(19) United States
(12) Patent Application Publication
(10) Pub. No.: US 2014/0309974 A1
(43) Pub. Date: Oct. 16, 2014

(54) OPTIMIZATION OF INPUT PARAMETERS OF A COMPLEX SYSTEM BASED ON MULTIPLE CRITERIA

(71) Applicant: THE REGENTS OF THE UNIVERSITY OF CALIFORNIA, Oakland, CA (US)

(72) Inventors: Chih-Ming HO, Brentwood, CA (US); Xianting DING, Los Angeles, CA (US); Genhong CHENG, Calabasas, CA (US); David J. SANCHEZ, Los Angeles, CA (US)

(21) Appl. No.: 14/253,452

(22) Filed: Apr. 15, 2014

Related U.S. Application Data
(60) Provisional application No. 61/812,204, filed on Apr. 15, 2013.

(51) Int. Cl. G06F 17/50

(52) U.S. Cl. CPC G06F 17/5009
USPC 703/2; 703/6; 703/12; 703/11

(57) ABSTRACT

A method of combinatorial optimization includes: (1) defining an objective function to optimize a combination of N input parameters of a complex system, wherein the objective function includes a weighted sum of n different optimization criteria, N≧2, and n≧2; (2) applying an initial combination of the N input parameters to the complex system to yield an initial output response; (3) executing an optimization procedure to generate an updated combination of the N input parameters, wherein executing the optimization procedure includes calculating an initial value of the objective function based on at least one of (a) the initial combination of the N input parameters and (b) the initial output response; and (4) applying the updated combination of the N input parameters to the complex system to yield an updated output response.

### CROSS-REFERENCE TO RELATED APPLICATION

This application claims the benefit of U.S. Provisional Application Ser. No. 61/812,204 filed on Apr. 15, 2013, the disclosure of which is incorporated herein by reference in its entirety.

### STATEMENT REGARDING FEDERALLY SPONSORED RESEARCH OR DEVELOPMENT

This invention was made with Government support under Grant No. EY018228, awarded by the National Institutes of Health. The Government has certain rights in the invention.

### FIELD OF THE INVENTION

This disclosure generally relates to the identification of optimized input parameters of a complex system and, more particularly, to the identification of such optimized combinations based on multiple criteria.

### BACKGROUND

Current drug discovery efforts have primarily focused on identifying agents that tackle specific preselected cellular targets. However, in many cases, a single drug does not correct all of the aberrantly functioning pathways in a disease to produce an effective treatment. Drugs directed at an individual target often have limited efficacy and poor safety profiles due to various factors, including compensatory changes in cellular networks upon drug stimulation, redundancy, crosstalk, and off-target activities. The use of drug combinations that act on multiple targets has been shown to be a more effective treatment strategy and is being used more frequently. This approach has been supported by successful clinical applications to treat various diseases, such as AIDS, cancer, and atherosclerosis. Often, studies used high dosages of individual drugs to ensure treatment efficacy. Unfortunately, the high dosages to provide efficacy often come with either, or both, toxic side effects and induced resistance. Therefore, treatments with a drug combination at the lowest optimal dosages are desirable to achieve the goal of high efficacy and low toxicity, resulting in the most desirable drug cocktail. However, identifying the combination of effective drugs, and determining the proper dosage of each drug is a challenging task. For example, even a small number of different drugs (six drugs) each tested at a few concentrations (seven dosages) results in 7⁶=117,649 combinations. Screening all 117,649 combinations for the most desirable combination is an enormous task in terms of labor and time. Furthermore, another problem with combinatorial medicine is that the highly efficacious drug combination may include one or more drugs that are toxic or have side effects.

It is against this background that a need arose to develop the combinatorial optimization technique described herein.

### SUMMARY

In some embodiments, a method of combinatorial optimization includes: (1) defining an objective function to optimize a combination of N input parameters of a complex system, wherein the objective function includes a weighted sum of n different optimization criteria, N≧2, and n≧2; (2) applying an initial combination of the N input parameters to the complex system to yield an initial output response; (3) executing an optimization procedure to generate an updated combination of the N input parameters, wherein executing the optimization procedure includes calculating an initial value of the objective function based on at least one of (a) the initial combination of the N input parameters and (b) the initial output response; and (4) applying the updated combination of the N input parameters to the complex system to yield an updated output response.

In other embodiments, a method of combinatorial drug optimization includes: (1) defining an objective function to optimize a combination of N drugs and respective dosages or dosage ratios, wherein the objective function includes a weighted sum of n different optimization criteria, at least one of the n optimization criteria corresponds to drug efficacy, N≧2, and n≧2; (2) conducting in vitro or in vivo tests by applying varying combinations of dosages of the N drugs to determine phenotypic responses corresponding to results of the tests; (3) fitting the results of the tests into a model of the objective function; and (4) using the model of the objective function, identifying at least one optimized combination of dosages of the N drugs.

In other embodiments, a method of combinatorial optimization includes: (1) defining an objective function to optimize a combination of N input parameters of a complex system, wherein the objective function includes a weighted sum of n different optimization criteria, N≧2, and n≦2; (2) conducting multiple tests of the complex system by applying varying combinations of the N input parameters to determine output responses corresponding to results of the tests; (3) fitting the results of the tests into a model of the objective function; and (4) using the model of the objective function, identifying at least one optimized combination of the N input parameters.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1: Combinatorial optimization of a complex system based on a closed-loop, feedback system control (FSC) technique, as implemented in accordance with an embodiment of this disclosure.

FIG. 2: A processing unit implemented in accordance with an embodiment of this disclosure.

FIG. 3: Setup of an experiment. (A) Plot of single drug dosages against efficacy. (B) Plot of infection percentage against multiplicity of infection (MOI). (C) Scheme of FSC: virus attempts to infect normal cells, while drug combinations are used to test for inhibition of virus infection. For a non-optimal drug combination, a majority of cells would become infected. More effective drug combinations, predicted in later iterations, lead to fewer infected cells. Iteratively, the procedure stops when an optimal drug combination is reached. Abbreviations: GFP, green fluorescent protein; HSV-1, herpes simplex virus-1.

FIG. 4: Application of FSC to search for high efficacy drug combinations. (A) The average objective function value in 16 drug combinations reduced as iteration proceeds. (B) After twelve iterations, the average dosage of ribavirin in 16 combinations increased, while the average dosages of the other antivirals was reduced. Abbreviations: TNF, tumor necrosis factor.

FIG. 5: Cascade FSC-based search for low ribavirin high efficacy combinations. (A) The average objective function value in 16 drug combinations reduced as iteration proceeds. (B) After 21 iterations, the average dosage of ribavirin in 16 combinations reduced to close to 0.

FIG. 6: Comparison between drug combinations from cascade FSC search and single antivirals. Notes: After single drug treatment, just ribavirin could achieve near 100% viral inhibition at the highest concentration used. Acyclovir did not involve high dosage when used as a single drug, but had a plateau in efficacy, leaving about 15% of cells infected. IFNs could not achieve perfect antiviral effectiveness even when used in high dosage. DE1 and DE2 combinations represent the optimal drug combinations from two rounds of drug screening. Both combinations had better antiviral effects and lower individual drug concentration than the individual component drugs. Abbreviations: IFNs, interferons.

FIG. 7: FSC identified drug combinations are more robust against changes in incubation time. (A) After HSV-1 infection, DE1 and DE2 were tested against incubation time ranging from 1 day to 4 days. Both combinations showed robustness to time change. (B) Plaque assay for extracellular supernatant showed that cells treated with both DE1 and DE2 release little virus through 4 days post infection. Notes: Data for individual drugs are available in FIGS. 10 and 11. Error bars represent the standard error of two experiments. Abbreviation: POS, positive control.

FIG. 8: Comparison between random drug combinations and cascade FSC identified drug combinations DE1 and DE2 from two FSC drug screens. Notes: Three randomly generated drug combinations, named R1, R2, and R3, are compared to DE1 and DE2. Both phase contrast pictures and fluorescent microscopy pictures are shown. The random drug combinations did not completely inhibit HSV-1 infection, while DE1 and DE2 nearly completely inhibited infection.

FIG. 9: Illustration of differential evolution (DE) search procedure. DE is divided into four main stages, which can be summarized as production of the original drug combinations, mutation stage, crossover stage, and production of the new drug combinations.

FIG. 10: Long-term test between optimized drug combinations and individual drugs. Both optimal drug combinations DE1 and DE2 show low percentage of infection from day 1 to day 4, while individual drugs in general lost their antiviral efficacy after day 3. Abbreviations: ACV, acyclovir.

FIG. 11: Plaque assay analysis of the viral titer in the supernatant. The supernatant of each sample from FIG. 10 was tested for the absolute viral titer using plaque assay. Viral titer gradually clears up by optimized drug combination DE1 and DE2 after 2 days.

### DETAILED DESCRIPTION

### Overview

Embodiments of this disclosure are directed to identifying optimized combinations of input parameters for a complex system. The goal of optimization of some embodiments of this disclosure can be any one or any combination of reducing labor, reducing cost, reducing risk, increasing reliability, increasing efficacies, reducing side effects, reducing toxicities, and alleviating drug resistance, among others. In some embodiments, a specific example of treating diseases of a biological system with optimized drug combinations (or combinatorial drugs) and respective dosages is used to illustrate certain aspects of this disclosure. A biological system can include, for example, an individual cell, a collection of cells such as a cell culture or a cell line, an organ, a tissue, or a multi-cellular organism such as an animal, an individual human patient, or a group of human patients. A biological system can also include, for example, a multi-tissue system such as the nervous system, immune system, or cardio-vascular system.

More generally, embodiments of this disclosure can optimize wide varieties of other complex systems by applying pharmaceutical, chemical, nutritional, physical, or other types of stimulations. Applications of embodiments of this disclosure include, for example, optimization of drug combinations, vaccine or vaccine combinations, chemical synthesis, combinatorial chemistry, drug screening, treatment therapy, cosmetics, fragrances, and tissue engineering, as well as other scenarios where a group of optimized input parameters is of interest. For example, other embodiments can be used for 1) optimizing design of a molecule (e.g., drug molecule or protein and aptamer folding), 2) optimizing the docking of a molecule to another molecule for biomarker sensing, 3) optimizing the manufacturing of materials (e.g., from chemical vapor deposition (CVD) or other chemical system), 4) optimizing alloy properties (e.g., high temperature super conductors), 5) optimizing a diet or a nutritional regimen to attain desired health benefits, 6) optimizing ingredients and respective amounts in the design of cosmetics and fragrances, 7) optimizing an engineering or a computer system (e.g., an energy harvesting system, a computer network, or the Internet), and 8) optimizing a financial market.

Input parameters can be therapeutic stimuli to treat diseases or otherwise promote improved health, such as pharmaceutical (e.g., drugs), biological (e.g., protein therapeutics, DNA or RNA therapeutics, or immunotherapeutic agents, such as cytokines, chemokines, and immune effector cells such as lymphocytes, macrophages, dendritic cells, natural killer cells, and cytotoxic T lymphocytes), chemical (e.g., chemical compounds or ionic agents), naturally-derived compounds (e.g., traditional eastern medicine compounds), electrical (e.g., electrical current or pulse), and physical (e.g., pressure, shear force, or thermal energy, such as through use of nanotubes, nanoparticles, or other nanostructures), among others. Diseases can include, for example, cancer, cardiovascular diseases, pulmonary diseases, atherosclerosis, diabetes, metabolic disorders, genetic diseases, viral diseases (e.g., human immunodeficiency virus, hepatitis B virus, hepatitis C virus, and herpes simplex virus-1 infections), bacterial diseases, and fungal diseases, among others. Optimization can include complete optimization in some embodiments, but also can include substantially complete or partial optimization in other embodiments.

Embodiments of this disclosure provide a number of benefits. For example, traditional drug discovery relies greatly on high-throughput screening, which applies brute force screening of millions of chemical, genetic, or pharmacological tests. Such approach has high cost, is labor-intensive, and generates a high amount of waste and low information density data. In contrast, embodiments of this disclosure provide a technique that allows a rapid search for identifying optimal drug combinations out of a multitude of possible combinations. Therefore, a small fraction of a total combinatorial input parameter space has to be tested. This, in turn, allows the possibility of screening combinatorial drugs in cases where limited samples are available, such as in the case of patient specimens for clinical or human testing, or animal specimens for animal testing.

In addition, different from traditional drug design approaches, which are often focused on individual signaling pathways or molecular interactions, embodiments of this disclosure can focus toward systemic, phenotypically-driven responses. Endpoint phenotypic responses, such as percentage of viral infected cells, cell viability, cell death, cell morphology, and protein expression levels, can be considered as system outputs. Therefore, embodiments of this disclosure can account for complex synergistic and antagonistic interactions inside biological systems that can be hardly revealed in traditional drug screening, including, for example, intracellular signaling pathway processes, linear and non-linear interactions, intermolecular interactions, intercellular interactions, and genotypic interactions and processes.

Also, considerable efforts are directed towards designing drug combinations for clinical treatments of diseases, such as viral infections, cardiovascular diseases, and cancer. While drug combinations designed according to traditional approaches can be generally effective, these approaches typically do not take into account a wide spectrum of disease manifestations. By focusing on a part of the spectrum, a fixed drug combination can ignore heterogeneity among different patients as well as other potential treatments. Consequently, a segment of patients may not respond well to a fixed drug combination, or a component of the drug combination may be too toxic or costly to be part of an efficacious treatment. Advantageously, embodiments of this disclosure provide a flexible technique that allows a rapid screen for case-specific drug combinations, thereby providing a foundation for personalized medicine. In some embodiments, the improved technique allows the design of a drug combination that optimizes therapeutic efficacy while allowing a reduced drug dosage to be engineered into the combination, thereby reducing toxicity or lowering costs for a truly optimized drug combination. In addition, the improved technique of embodiments of this disclosure allows the design of a drug combination based on different disease manifestation scenarios. For example, by adjusting or tuning a relative importance of multiple optimization criteria, drug combinations can be designed that satisfy individual patient requirements. Through such case-specific drug design, the design of drug combinations can incorporate therapeutic input from doctors as well as feedback from patients and doctors to compromise and balance between different drug design criteria, thereby identifying optimal drug combinations on a case-by-case basis, such as a patient-by-patient basis.

Some embodiments of this disclosure are implemented and validated in the context of drug combinations for treatment of herpes simplex virus-1, but the technique can be expanded toward other diseases and health-related applications, such as infectious diseases, nutraceuticals, herbal or eastern medication, homeopathic treatment, cosmetics, and probiotic optimization, among others. Imaging agents can be considered drugs in some embodiments, and these agents can be optimized as well. Furthermore, along with immunotherapy or chemotherapy regimens, rapid optimization of drug therapy in concert with such regimens can be attained as well.

### Optimized Combinations of Input Parameters for a Complex System

Stimulations can be applied to direct a complex system toward a desired state, such as applying drugs to treat a patient having a disease. The types and the values (e.g., amplitudes or dosages) of applying these stimulations are part of the input parameters that can affect the efficiency in bringing the system toward the desired state. However, N types of different drugs with M dosages for each drug will result in M^{N} possible drug-dosage combinations. To identify an optimized or even near optimized combination by multiple tests on all possible combinations is prohibitive in practice. For example, it is not practical to perform all possible drug-dosage combinations in animal and clinical tests for finding an effective drug-dosage combination as the number of drugs and dosages increase.

Embodiments of this disclosure provide a technique that allows a rapid search for optimized combinations of input parameters to guide multi-dimensional (or multi-variate) engineering, medicine, financial, and industrial problems, as well as controlling other complex systems with multiple input parameters toward their desired states. An optimization technique can be used to identify at least a subset, or all, optimized combinations or sub-combinations of input parameters that produce desired states of a complex system. Taking the case of combinational drugs, for example, a combination of N drugs can be evaluated to rapidly identify optimized dosages of the N drugs, where N is greater than 1, such as 2 or more, 3 or more, 4 or more, 5 or more, 6 or more, 7 or more, 8 or more, 9 or more, or 10 or more.

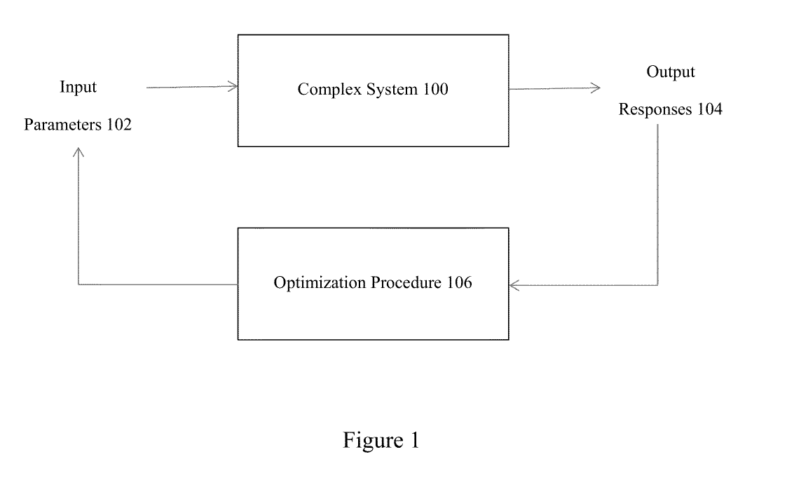

In some embodiments, combinatorial optimization of a complex system is based on a closed-loop, feedback system control (FSC) technique, as implemented and shown in FIG. 1. The FSC technique is implemented with four modules or parts: 1) a biological or other complex system 100 of interest; 2) input parameters 102 that are applied to the system 100; 3) output responses 104 of the system 100 to the input parameters 102, where the output responses 104 are observed, sensed, measured, or otherwise determined from the system 100; and 4) an optimization or search procedure 106 that takes into account current input parameters 102 and current output responses 104, and generates updated input parameters 102 for a next iteration. At the next iteration, the updated input parameters 102 are applied to the system 100 to yield updated output responses 104, and so on. As the iterations progress, the optimization procedure 106 continues to generate potential optimized combinations of the input parameters 102 until the system 100 reaches a desired outcome or state.

In some embodiments, the system 100 can include a group of test subjects, such as multiple cell cultures in the case of in vitro testing or multiple test animals or human patients in the case of in vivo testing, and, as the iterations progress, updated input parameters can be applied or administered to different members of the group of test subjects. In other embodiments, updated input parameters can be applied to the same test subject or the same group of test subjects as the iterations progress.

Operation of the optimization procedure 106 is according to an objective function OF (or a cost function) that is defined or specified for the system 100 being evaluated. As the iterations progress, the optimization procedure 106 calculates or otherwise derives an updated value of the optimization OF from the current input parameters 102 and the current output responses 104. In some embodiments, the objective function OF is represented as a weighted combination or a weighted sum of different optimization criteria as follows:

$$OF ( X ) = {\sum }_{i = 1}^{n} [ {w}_{i} \times {OC}_{i} ( X ) ] \qquad ( 1 )$$

where X is a vector of input parameters in an input parameter space, OCᵢ is an i^{th} optimization criterion that is a function of X, wᵢ is a weighting factor that can be adjusted or tuned to determine a relative weight of OCᵢ in the objective function, n is a total number of different optimization criteria in the objective function, and n is greater than 1, such as 2 or more, 3 or more, 4 or more, 5 or more, 6 or more, 7 or more, 8 or more, 9 or more, or 10 or more. In some embodiments, a sum of all weighting factors is 1 (e.g., w₁+w₂+ . . . wₙ=1), although a value of this sum can be varied for other embodiments. In addition to the above equation (1), other representations of the objective function OF are contemplated and encompassed by this disclosure.

Taking the case of combinational drugs, for example, X is a vector of N dosages of a combination of N drugs being evaluated, and OCᵢ is an i^{th} optimization criterion in the design of the combination of N drugs. Examples of optimization criteria include drug efficacy, drug toxicity, drug safety, drug side effects, drug tolerance, therapeutic window, drug dosage, and drug cost, among others. In the above equation (1), the objective function OF represents an overall outcome or response to be optimized (e.g., reduced or minimized, or enhanced or maximized), and is a weighted sum of the n different optimization criteria. In some embodiments, at least one of the n different optimization criteria can correspond to a phenotypic response of the system 100 that is subjected to X. For example, at least one optimization criterion can correspond to drug efficacy, such as in terms of a fraction or a percentage of infected cells (or other infected test subjects) after treatment with X, or a viability of diseased cells (or other diseased test subjects) after treatment with X. As another example, at least one optimization criterion can correspond to drug safety or toxicity, such as in terms of a viability of healthy control cells (or other healthy control test subjects) after treatment with X. An optimization criterion can directly correspond an output response 104 (e.g., a phenotypic response) of the system 100, or can be calculated or otherwise derived from one or more output responses 104 (e.g., one or more phenotypic responses), such as by applying proper transformations to adjust a range and scale of the output responses 104.

Certain phenotypic responses are desirable, such as drug efficacy, drug safety, drug tolerance, or therapeutic window, while other phenotypic responses are undesirable, such as drug toxicity or drug side effects. In the case of the latter phenotypic responses, their weighting factors serve as penalty factors in the optimization of the combination of N drugs. Also through penalty factors, the design of the combination of N drugs can optimize drug efficacy while allowing a reduced drug dosage or a reduced drug cost to be accounted in the optimization. Various weighting factors in the equation (1) can be adjusted or tuned to reflect the relative importance of desirable optimization criteria and undesirable optimization criteria, and the adjustment or tuning can be performed on a case-by-case basis to yield different optimized dosages of the N drugs depending on particular requirements. Also, the adjustment or tuning of the weighting factors can be performed over time so as to incorporate feedback from patients and doctors over the course of a treatment.

As the iterations progress, the optimization procedure 106 optimizes the objective function OF, such as using a stochastic or a deterministic optimization technique. Examples of stochastic techniques include simulated annealing, stochastic local search, stochastic hill-climbing, Metropolis-Hastings sampler, greedy randomized adaptive search, Markov chain Monte Carlo (MCMC), genetic optimization, Differential Evolution, and Gur game, among others. Examples of deterministic techniques include steepest descent and conjugate gradient, among others. Advantageously, convergence of the system 100 toward a desired outcome or state can be rapidly attained, such as within 100 iterations, within 80 iterations, within 60 iterations, within 40 iterations, within 20 iterations, or within 15 iterations, thereby reducing the number of in vitro or in vivo tests to be conducted and greatly enhancing the speed and lowering labor and costs compared with traditional drug screening. Certain aspects of optimization techniques can be implemented as set forth in U.S. Pat. No. 8,232,095, entitled “Apparatus and methods for manipulation and optimization of biological systems” and issued on Jul. 31, 2012, the disclosure of which is incorporated herein by reference in its entirety.

In other embodiments, combinatorial optimization of a complex system is based on an extension of the FSC technique, as discussed in the following.

First, an experimental design procedure is used to guide the selection of tests to sample an input parameter space. Typically, combinations of input parameters that are sampled represent a small fraction of all possible combinations in the input parameter space, such as less than about 20%, less than about 15%, less than about 10%, less than about 5%, or less than about 1%. The experimental design procedure can allow exposure of salient features of a complex system being evaluated, and can reveal a combination or sub-combination of input parameters of greater significance or impact in affecting a state of the system. Selection of the experimental design procedure can be according to a particular model of the system being evaluated. Examples of experimental design procedures include latin hypercube sampling, central composite design, d-optimal design, orthogonal array design, full factorial design, and fractional factorial design, among others.

Next, an objective function OF is defined or specified for the system being evaluated, such as according to the equation (1). As discussed above with reference to the equation (1), the objective function OF represents an overall outcome or response to be optimized, and is a weighted sum of n different optimization criteria.

Next, output responses of the system (e.g., phenotypic responses) are measured by testing each combination of input parameters sampled according to the experimental design procedure, such as by administering each sampled combination of dosages of N drugs in vitro or in vivo, such as in clinical or human tests. In some embodiments, the in vitro or in vivo tests can be conducted in parallel in a single in vitro study or a single in vivo study, thereby greatly enhancing the speed and lowering labor and costs compared with traditional drug screening.

Next, a model (e.g., a regression model or other mathematical model) of the objective function OF is fitted using values of the objective function OF calculated from test results. Fitting of the model can be carried out by linear regression, Gaussian process regression, support vector machine regression, Bayesian regression, neural network, or another suitable technique.

Next, an optimized combination of input parameters is determined or predicted using the model, such as by optimizing the model with a stochastic or a deterministic optimization technique, or by using an extrema locating technique (e.g., a global or local maximum or minimum).

Finally, the optimized combination of input parameters is verified, such as by applying the optimized combination in vitro or in vivo, such as in clinical or human tests.

### Processing Unit

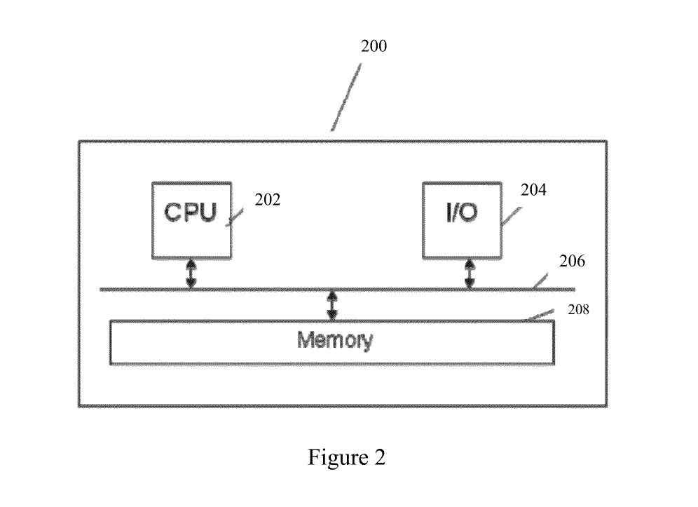

FIG. 2 shows a processing unit 200 implemented in accordance with an embodiment of this disclosure. Depending on the specific application, the processing unit 200 can be implemented as, for example, a portable electronics device, a client computer, or a server computer. Referring to FIG. 2, the processing unit 200 includes a central processing unit (“CPU”) 202 that is connected to a bus 206. Input/Output (“I/O”) devices 204 are also connected to the bus 206, and can include a keyboard, mouse, display, and the like. An executable program, which includes a set of software modules for certain procedures described in the foregoing sections, is stored in a memory 208, which is also connected to the bus 206. The memory 208 can also store a user interface module to generate visual presentations.

An embodiment of this disclosure relates to a non-transitory computer-readable storage medium having computer code thereon for performing various computer-implemented operations. The term “computer-readable storage medium” is used herein to include any medium that is capable of storing or encoding a sequence of instructions or computer codes for performing the operations described herein. The media and computer code may be those specially designed and constructed for the purposes of this disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs), and ROM and RAM devices. Examples of computer code include machine code, such as produced by a compiler, and files containing higher-level code that are executed by a computer using an interpreter or a compiler. For example, an embodiment of the invention may be implemented using Java, C++, or other object-oriented programming language and development tools. Additional examples of computer code include encrypted code and compressed code. Moreover, an embodiment of the invention may be downloaded as a computer program product, which may be transferred from a remote computer (e.g., a server computer) to a requesting computer (e.g., a client computer or a different server computer) via a transmission channel. Another embodiment of the invention may be implemented in hardwired circuitry in place of, or in combination with, machine-executable software instructions.

### EXAMPLE

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

### Example 1

### Cascade Search for HSV-1 Combinatorial Drugs with High Antiviral Efficacy and Low Toxicity

Overview

Infectious diseases cause many molecular assemblies and pathways within cellular signaling networks to function aberrantly. A particularly effective way to treat complex, diseased cellular networks is to apply multiple drugs that attack the problem from many fronts. However, determining the optimal combination of several drugs at specific dosages to reach an endpoint objective is a daunting task. In this example, an experimental feedback system control (FSC) technique is applied to rapidly identify optimal drug combinations that inhibit herpes simplex virus-1 infection, by testing less than about 0.1% of the total possible drug combinations. Using antiviral efficacy as the criterion, FSC quickly identified a highly efficacious drug cocktail. This cocktail included a high dose of ribavirin. Ribavirin, while being an effective antiviral drug, often induces toxic side effects that are not desirable in a therapeutic drug combination. To screen for less toxic drug combinations, a second FSC search is applied in cascade, using both high antiviral efficacy and low toxicity as criteria. Surprisingly, the new drug combination eliminated the need for ribavirin, but still blocked viral infection in nearly 100% of cases. This cascade search provides a versatile platform for rapid discovery of new drug combinations that satisfy multiple criteria.

Introduction

Viral infections have stood out as an interesting candidate for combination drug therapy. Human immunodeficiency virus (HIV), hepatitis C virus, and influenza infections have been shown to be effectively treated by combinations of antiviral drugs. The pathogenesis of viral infections is caused by a coordinated reprogramming of cellular pathways and protein complexes by viral factors to favor the replication and spread of the virus. Within these pathways and protein complexes, single targets have been found that upon drug manipulation can disrupt viral replication. However, intervention against a single drug target usually results in the selection of escape mutants that are ineffectively suppressed by the single drug. The preferred method is to target multiple viral pathways simultaneously, so that the drugs target distinct steps of viral replication to more effectively block replication and reduce the likelihood that a multiple drug-resistant mutant will arise.

Herpes simplex virus-1 (HSV-1) is one of the most pervasive infections worldwide, causing genital, skin, and eye infections in millions of people. Common treatments for HSV-1, including virus-specific drugs such as acyclovir, are effective but exhibit limited long-term efficacy due to the development of drug-resistant strains. Thus, more effective therapeutic methods are desired to combat the increasing spread of drug-resistant HSV-1. Based on an intensive literature search, six drugs associated with antiviral gene regulation, viral proliferation, cell growth, and cell death were selected in experiments as candidates for establishing a new combination drug therapy. First, the HSV-1 antiviral drug acyclovir, which is effective for the treatment of most herpes virus infections, acts as a chain terminator of DNA polymerase in virus infected cells. Acyclovir is also an effective control to measure efficacy. The second drug that is included was ribavirin, which has antiviral activity against RNA virus infections such as poliovirus and hepatitis C virus but the mechanism for antiviral activity against DNA viruses, such as HSV-1, remains unknown. Next, three cellular produced interferons (IFNs), IFN-α, IFN-β, and IFN-γ, are included that have potent antiviral effects through the induction of cellular innate immune pathways. Finally, tumor necrosis factor (TNF)-α, a cellular protein that induces activation of nuclear factor kappa B (NF-κB) and cellular death pathways, is included. Each of these drugs can potentially block HSV-1 replication by modulating distinct viral or cellular protein complexes and pathways, and thus represent distinct potential therapies. Therefore, a combination of these drugs should be a highly efficacious drug therapy.

Instead of testing all possible combinations of these drugs at different dosages by a high-throughput screen, an experimental feedback system control (FSC) technique can identify optimal drug combinations by testing about 0.1% or less of all possible combinations. Here, this example successfully applies the FSC technique in experiments to search for drug combinations that have high antiviral efficacy, and then FSC is applied in cascade to lower the dosages of a toxic drug (ribavirin) for the treatment of HSV-1 using an in vitro infection model.

Methods

Procedures: Differential Evolution (DE) technique was coded with MATLAB software (Mathworks Inc., Natick, Mass.). Each drug combination was represented as a vector in the software. Coded dosage was used rather than absolute concentration. The dosages of 16 combinations in the first iteration were chosen arbitrarily. The code computed the objective function value of each combination, and suggested a new group of drug combinations to test in the following iteration.

Reagents: IFN-α, IFN-β, and IFN-γ were purchased from PBL Interferon Source (Piscataway, N.J.). Ribavirin and acyclovir were purchased from Calbiochem (San Diego, Calif.). TNF-α was purchased from R&D Systems (Minneapolis, Minn.). Dulbecco's Modified Eagle's Medium (DMEM) was purchased from CELLGRO (Manassas, Va.) and Fetalplex from Gemini Bio-Products (Woodland, Calif.). Penicillin/streptomycin and Trypsin-ethylenediaminetetraacetic acid (EDTA) were obtained from GIBCO (Grand Island, N.Y.). Paraformaldehyde (PFA) was purchased from Electron Microscopy Sciences (Hatfield, Pa.). Phosphate buffered saline (PBS) was purchased from EMD (Rockland, Mass.). All other plates and tubes were from BD Falcon (San Jose, Calif.).

Cell culture: NIH 3T3 cells were grown on 15 cm plates in DMEM supplemented with about 5% Fetalplex and about 1% penicillin/streptomycin and kept in an about 37° C. incubator with about 5% CO₂. To propagate cells, the experiments involved plating 107 on each 15 mm plate and splitting the cells every 24 hours. For each experimental iteration, the experiments plated 2×105 cells/well in a 24-well plate. To minimize variance generated from different batches of cells, the trial group and crossover group were tested and compared using the same batch of cells for each iteration.

Viral infection: HSV-1 KOS strain expressing green fluorescent protein (GFP) in frame with the ICPO protein between amino acids 104 and 105 was used. The virus was prepared by propagation of virus on a confluent monolayer of Vero cells. Supernatants from infected cells were collected and centrifuged to separate cell debris. The cell pellet in residual medium was frozen and thawed three times at about −80° C. and about 37° C., respectively. The residual supernatant was then pooled together with the original supernatant, and viral titers were determined by a standard plaque assay on Vero cell monolayers. Multiplicity of infection (MOI) of about 0.1 was used throughout except as indicated. To control MOI, cells, virus, and drug combinations were added at the same time and incubated at about 37° C. After about 17 hours, culture medium was aspirated, and cells were detached with PBS-EDTA treatment at about 37° C. for about 5 minutes. Detached cells were transferred to flow cytometry tubes, pelleted, and re-suspended in about 1.6% PFA and kept at about 4° C. until analysis. A BD FACS Canto II was used for flow cytometry analysis.

Results

HSV-1 infectious disease model: HSV-1 infection on an NIH 3T3 fibroblast cell line was used as an in vitro model system to search for new therapeutic drug combinations. The antiviral drugs that are used in the therapeutic model include three antiviral cytokines (IFN-α, IFN-β, and IFN-γ), ribavirin, acyclovir, and TNF-α. Virus-infected cells were treated with single drugs or drug combinations and cultured for about 16 hours. The HSV-1 strain used to infect the NIH 3T3 cells encodes a GFP reporter in infected cells, allowing flow cytometric analysis of cells to measure the rate and extent of infection, because the fluorescence intensity of GFP correlated to the presence of virus. Determination of efficacy of drug treatments was made by comparing the number of GFP-negative non-infected cells in the absence or presence of drug treatment. This value was considered the antiviral readout of a drug treatment.

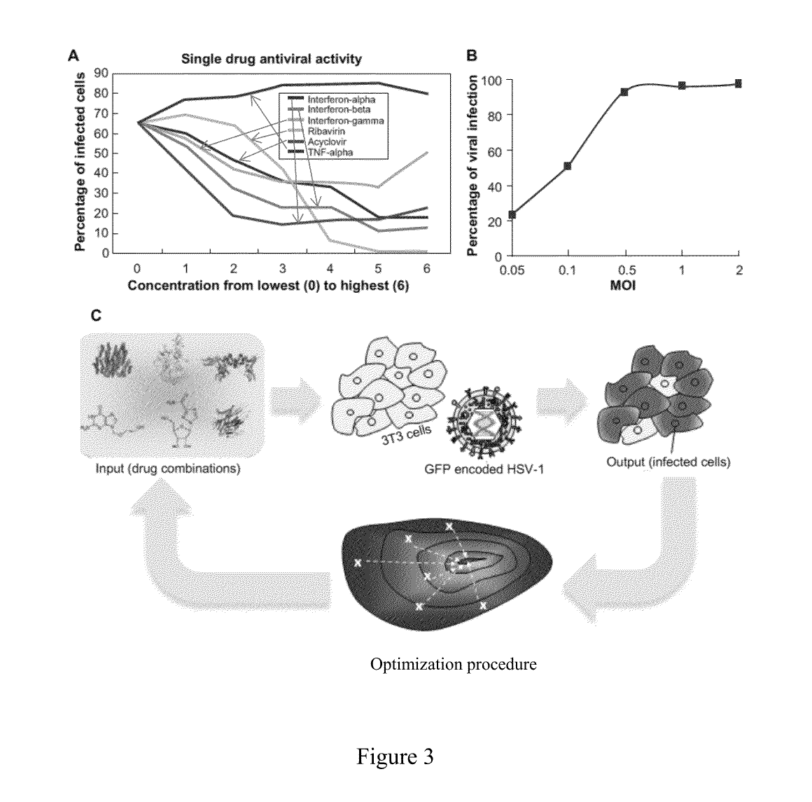

The success of antiviral drug combinations depends on at least two factors: the drug combination used and the dosage of each drug used. In this example, seven dosage concentrations for each of the six drugs were evaluated. Consequently, the total possible combinations of drugs and dosages are 7⁶=117,649. The dosage levels were coded with numbers from 0 to 6, where 0 stands for a dosage of zero, 6 is the highest dosage used for that drug, and 5 to 1 are four-fold dilutions from the highest dosage. The absolute concentrations, as well as the antiviral readouts (percentage of infected cells following treatment), are shown in Table 1 and FIG. 3A. This example shows that ribavirin is an effective drug, inhibiting HSV-1 infection by about 95% at very high dosages. Treatment with any of the IFNs or acyclovir reduced the infection rate, though a large percentage of cells were infected despite drug treatment. In contrast, TNF-α treatment actually potentiated HSV-1 infection, resulting in more infected cells than the non-treated control. Despite the observation that TNF-α enhanced the infection rate, it was kept in the combination drug test for two reasons. First, TNF-α could have an antiviral effect if used in combination with other drugs. Second, if TNF-α had no antiviral effect or enhanced HSV-1 infection, it was sought to determine whether it would be screened out of the possible drug combinations by the FSC technique.

The infectious dose of HSV-1 used (MOI: number of infectious virions per cell) is an important parameter when evaluating the outcome of potential therapies. Using a very high MOI resulted in rapid cell death, but a low MOI did not sufficiently reflect the antiviral effectiveness of different drug combinations for inhibiting HSV-1 infection. In this example, it was found that the viral infection level was a monotonic function of MOI and reached a plateau MOI of about 0.5 (FIG. 3B). In general, HSV-1 infection with an MOI of about 0.1 in the absence of any drug resulted in an infection rate of about 60% (GFP-positive cells) at about 16 hours post-infection. An MOI of about 0.1 was used throughout the studies.

TABLE I
Concentration of drugs (ng/mL)

| | | | | | | | |
|---|---|---|---|---|---|---|---|
| IFN-α | 0 | 0.2 | 0.78 | 3.12 | 12.5 | 50 | 200 |
| IFN-β | 0 | 0.2 | 0.78 | 3.12 | 12.5 | 50 | 200 |
| IFN-γ | 0 | 0.2 | 0.78 | 3.12 | 12.5 | 50 | 200 |
| Ribavirin | 0 | 98 | 390 | 1560 | 6250 | 2.5e4 | 1e5 |
| Acyclovir | 0 | 20 | 80 | 320 | 1250 | 5e3 | 2e4 |
| TNF-α | 0 | 0.02 | 0.08 | 0.32 | 1.25 | 5 | 20 |
| Coded | 0 | 1 | 2 | 3 | 4 | 5 | 6 |
| concentration | | | | | | | |
| levels | | | | | | | |

The FSC technique: The FSC technique was implemented with four modules. The first module was the input stimulations, namely, the drug combinations. The second module was the bio-complex system of interest, which in this case was the virus and host cell. The third module was the objective function readouts, which were the goals for optimization, such as efficacy, toxicity, alleviating drug resistance, and so forth. The fourth module was the optimization procedure, which provided the next set of stimulant dosages for directing the bio-complex system toward the desired phenotype (FIG. 3C).

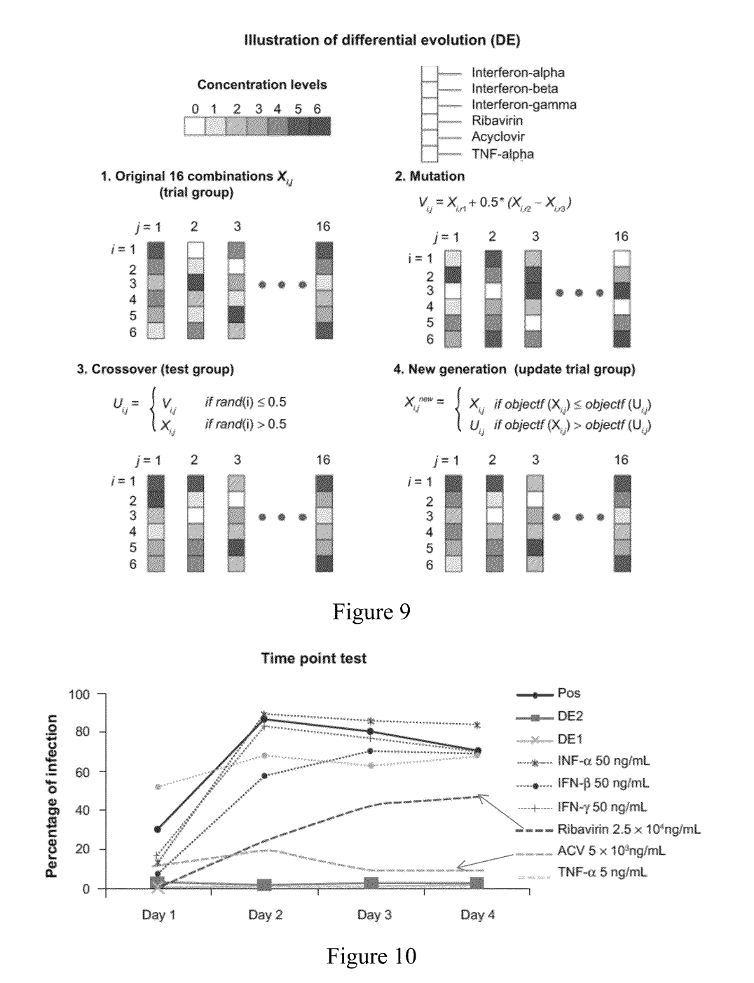

For the FSC technique, a starting point involved a set of drugs at arbitrarily chosen concentrations to stimulate the cells infected with HSV-1. The percentage of the host cells that become infected was used as the endpoint readout of the objective function in the third FSC module, and will most likely not be satisfactory in the first permutation. The fourth module of the FSC technique used an optimization procedure to determine a selection of drug concentrations with potentially improved performance, which was used in the next iteration of the experiment and fed back into the bio-complex system. Iterations of this feedback continued until the optimal drug combination was reached, namely when the system objective function became satisfactory. The optimization procedure was the FSC module that directed the tested drug combinations towards an optimal treatment for the bio-complex system. In this example, a differential evolution (DE) procedure was applied. DE is a parallel search procedure in which several drug combinations are tested in each iteration of the procedure. A diagram of the process for implementing DE in the HSV-1 inhibition experiments is shown in FIG. 9.

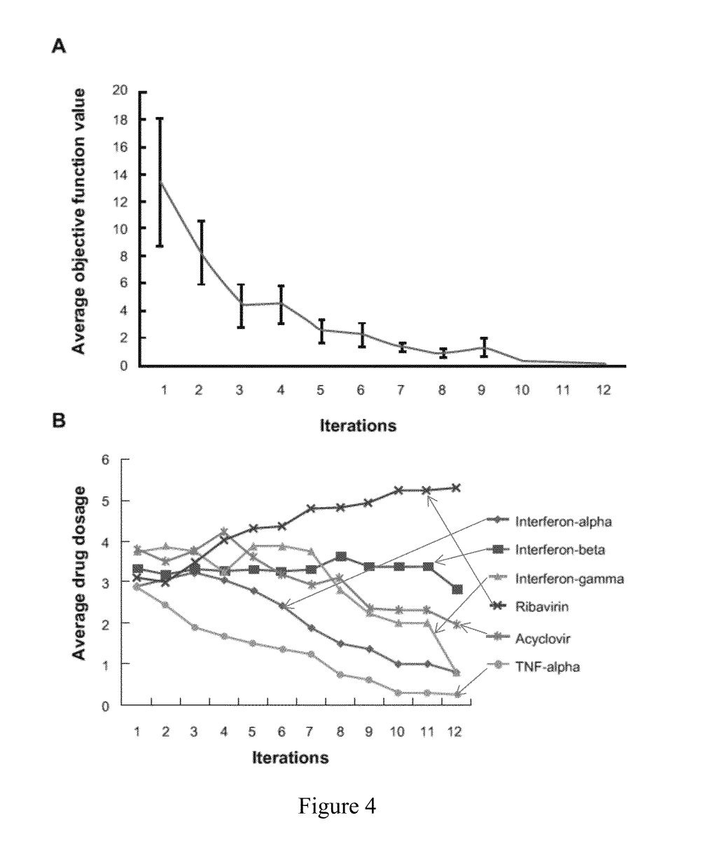

The search for high efficacy drug combinations: In the first part of the experiments, inhibition of viral infection was the sole objective function used in the FSC screening for drug combinations. To initiate the FSC process, 16 parallel drug combinations with arbitrarily chosen concentrations were generated using the numerical analysis software MATLAB. As FSC progressed, the 16 drug combinations were updated in such a way that the combination drug treatment reduced the percentage of HSV-1-infected cells. FIG. 4A shows the average objective function value of the 16 combinations as the iterations progress. This value reached a plateau at the 8th iteration. As FSC continued, the average dosage levels for each of the six drugs in the 16 combinations were reduced, except for the dosage of ribavirin (FIG. 4B). At the 12th iteration, FSC predicted a drug combination of about 0.2 ng/mL IFN-β, about 80 ng/mL acyclovir, and about 25 ng/mL ribavirin. Treatment of HSV-1-infected cells for about 16 hours with this drug combination resulted in less than about 0.1% GFP-positive cells, indicating that it substantially completely blocked HSV-1 infection. This drug combination is designated DE1. For comparison, treatment with the highest dose of ribavirin resulted in about 5% of cells becoming HSV-1-infected.

In order to verify the efficacy of DE1, testing of DE1 was carried out on a more vicious viral strain, HSV-1 strain 17. The optimal drug combinations DE1 and a non-optimal drug combination of (about 0.78, about 0.78, about 0.2, 0, 0, about 5) ng/mL (IFN-α, IFN-γ, ribavirin, acyclovir, TNF-α) were tested. Cells were co-treated with drug combinations and HSV-1 strain 17 (MOI=about 1) for about 1 hour, followed by two times wash with regular cell culture medium (DMEM with about 5% FBS and about 1% Pen-Strep). The cells were then left in fresh culture medium for about 24 hours. Supernatant of each sample was then subjected to the plaque assay in order to assess the viral titer in the supernatant. The results indicated that the optimal drug combination DE1 (optimized for KOS strain) is still very effective, inhibiting about ten-fold of the strain 17 infection. Meanwhile, the non-optimal drug combination did not exhibit much inhibition of either KOS or strain 17. This positive result indicates the same trend in efficacy for two HSV-1 strains.

The search for high efficacy and low toxicity antiviral combinations by cascading FSC search: The drug combination DE1 includes a high dose of ribavirin. However, side effects for high doses of ribavirin are a drawback of this drug. Ribavirin has been reported to cause anemia, to be teratogenic in some animal tests, and to inhibit DNA synthesis in a dosage dependent manner. Therefore, it was attempted to determine whether FSC can search for a drug combination that simultaneously satisfies two criteria: (1) high antiviral efficacy and (2) low toxicity (here, lower ribavirin dosage).

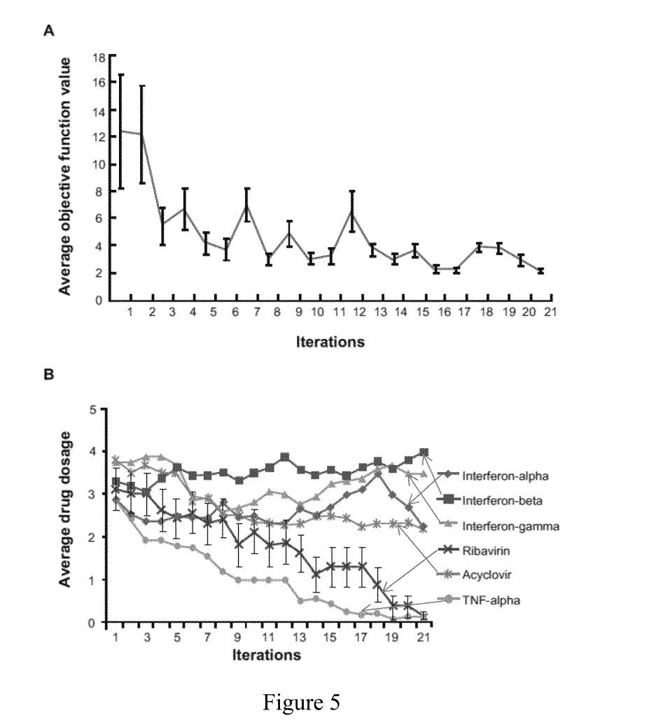

For this search, a different objective function, OF=αVᵢ+βR_{c}, where V, stands for the percentage of infected cells after drug treatment, R_{c} stands for the coded dosage of ribavirin, from 0 to 5, and α and β are called penalty (or weighting) factors. With the introduction of penalty factors, a hybrid objective function for the fourth FSC module was created with these multiple criteria applied to the FSC optimization procedure. The values of α and β reflect the relative importance of Vᵢ and R_{c}. To ensure high efficacy, α is set to 0.9, and β is set to 0.1 to screen out drug combinations with higher dosages of ribavirin. Thus, the hybrid objective function is OF=0.9Vᵢ+0.1R_{c}. To verify whether this addition to the cascade FSC drug screening technique could direct the bio-complex system to satisfy this hybrid objective function for low toxicity and high efficacy, the same 16 initial combinations were applied in a second search. As FSC proceeded through the iterations, the average objective function value approached a plateau after about 12 iterations (FIG. 5A). Strikingly, at the 21st iteration, the average concentration of ribavirin in the 16 combinations was close to 0 (FIG. 5B). The FSC predicted a ribavirin-free combination of about 3.12 ng/mL IFN-β, about 3.12 ng/mL IFN-γ, and about 80 ng/mL acyclovir. Surprisingly, this ribavirin-free drug cocktail inhibited about 95% HSV-1 infection of the treated culture. This combination is designated DE2 in the rest of this example.

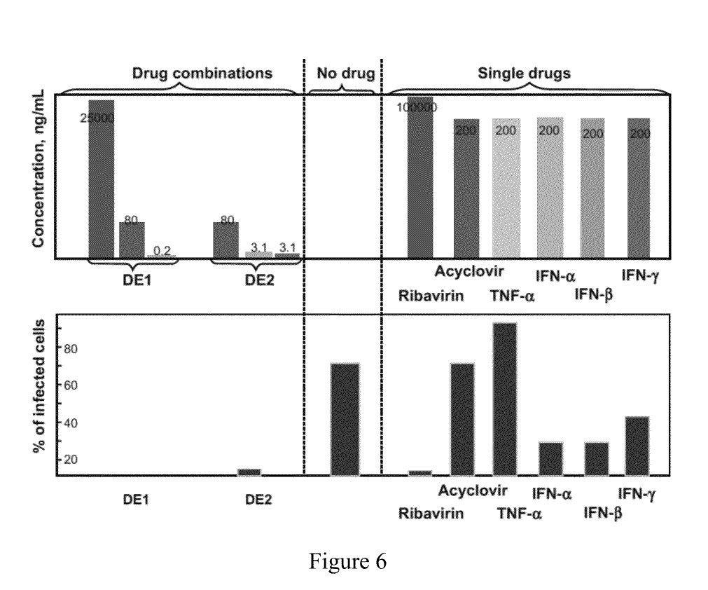

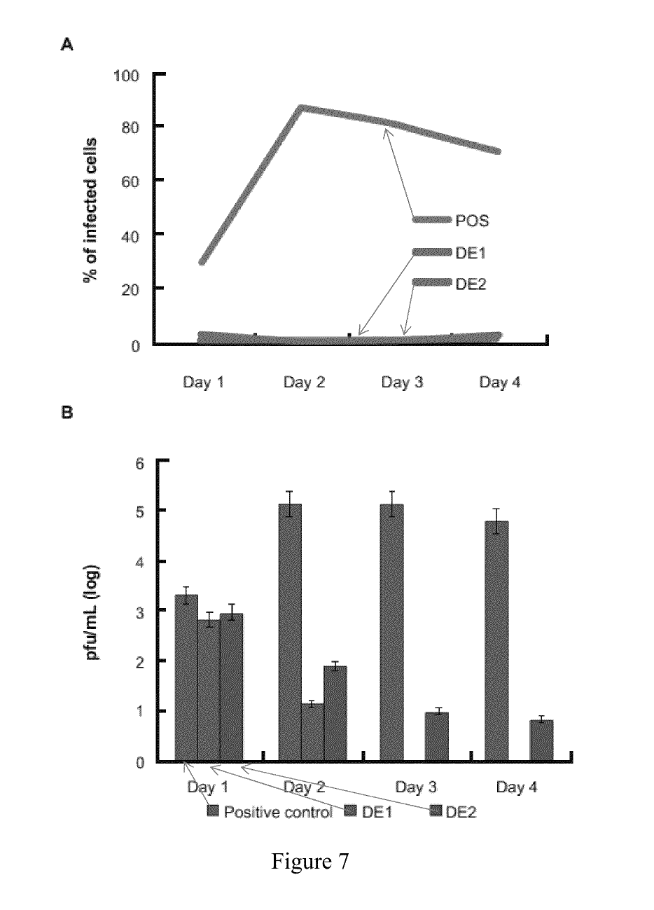

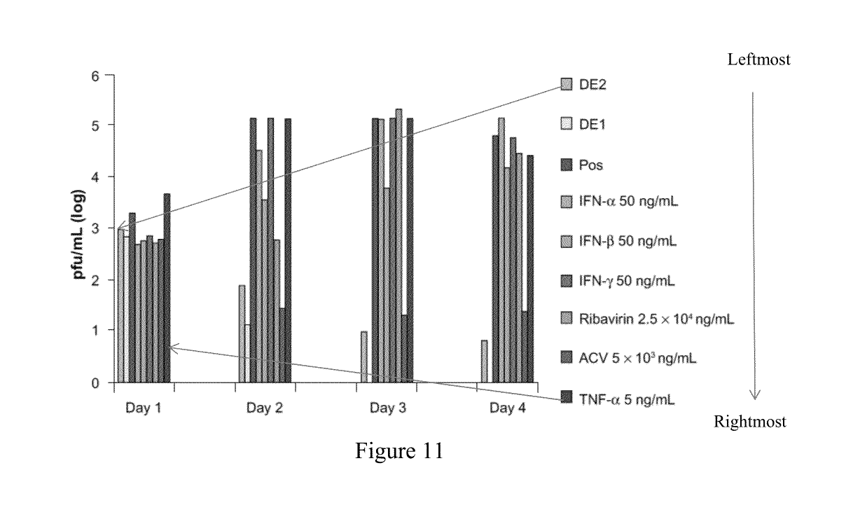

Comparison between FSC identified combinations and single antiviral drugs: Both drug combinations DE1 and DE2 were able to inhibit viral infection by about 100%, which could not be achieved by using any of the single drugs alone. Compared to single drug treatment, both DE1 and DE2 offer lower dosages of the drugs and greater antiviral efficacy (FIG. 6). Additionally, HSV-1-infected cells were cultured for longer time points, ranging from 1 day to 4 days, in the presence of DE1 or DE2. Both DE1- and DE2-treated samples sustained low levels of viral infection through day 4 (FIG. 7A). It was found that treatment with the different IFNs had decreased efficacy as time increased, and ribavirin showed a similar decrease in efficacy over time (FIG. 10). In contrast, antiviral activity of acyclovir remained constant as time increased. To independently confirm the flow cytometry results for the time course experiment, the HSV-1 virus yield in the culture supernatants was determined by plaque assay of the time course. The infectious titers of the supernatants were consistent with the flow cytometry results, confirming the antiviral effect of the DE1 and DE2 drug combinations (FIG. 7B and FIG. 11).

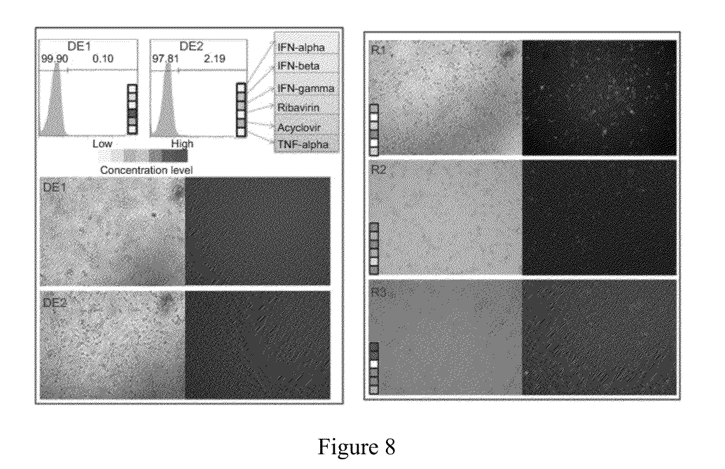

Comparison between FSC identified combinations and random combinations: Next, a comparison is made of the drug efficacy of the FSC identified drug combinations with three random combinations of the six antiviral drugs. Both flow cytometry analysis and GFP fluorescent images are shown in FIG. 8. In FIG. 8, both DE1 and DE2 treatment almost completely blocked infection, resulting in <about 5% GFP-positive cells; however, there were about 50% to about 80% virus-infected cells when treated with the random combinations.

Discussion

This example demonstrates that the cascade FSC scheme is a very versatile technique in identifying optimal drug combinations to achieve multiple desired biological endpoint results. Here, it is shown that cascade FSC can be used successfully to rapidly search combinations of multiple drugs for optimal dosages to satisfy both high efficacy and low toxicity. In this example, drug efficacy is first used as the sole endpoint objective criterion. In the cascade screen, penalty factors are introduced against high doses of ribavirin, and a distinct, effective, drug combination was found that did not include ribavirin. This is important because high dosages of ribavirin could be toxic, including possible teratogenic effects. Further, this example shows the flexibility of the cascade FSC technique in that it allows greater freedom to design screens for optimal drug combinations based on various criteria. In principle, even more parameters can be added to the FSC-based search for drug combinations, including degree of off-target effects or other important factors that determine the clinical significance of drug combinations.

For drugs that have no positive contribution to viral infection, such as TNF-α in the current example, each iteration of the FCS suggested a decreased TNF-α dosage, with the dosage eventually dropping to and remaining at zero. Together, these results show that the FSC technique is an effective drug screening process.

DE1 and DE2 are both effective at blocking HSV-1 infection. An interesting but challenging question is how these drug combinations work synergistically to affect a group of genes, which eventually leads towards the inhibition of infection. The first step is to identify the target genes influenced by a single drug. Assisted by high-throughput screening technique, the interactions among the pathways and mechanisms under stimulations of combinatorial drugs can then be studied step by step.

DE1 and DE2 represent two distinct drug combinations that work much more efficiently at blocking HSV-1 infection/replication than the individual drugs alone. DE1 is a combination of acyclovir, ribavirin, and a low level of IFN-β, while DE2 is a combination of acyclovir and both IFN-α and IFN-β. However, acyclovir by itself does not block HSV-1 replication as effectively as DE1 or DE2 treatment. The high antiviral efficacy of DE1 and DE2 is attributed to the combinations acting on multiple cellular signaling networks simultaneously. In DE1, ribavirin is present at a concentration high enough to engage other unclear signaling pathways, working in concert with acyclovir and IFN-β to direct a global antiviral activity. In addition, these drug combinations could potentiate new pathways that disrupt HSV-1 replication that are not triggered by single drugs alone. For example, either, or both, IFN-β and ribavirin could potentiate the effect of acyclovir to induce apoptosis in HSV-1-infected cells. Similarly, in the absence of ribavirin in DE2, it is believed that the combined effects of IFN-α and IFN-β synergize with acyclovir to block HSV-1 replication. Further studies aimed at elucidating the mechanisms of how these antiviral drugs work in combination can lead to greater insight on HSV-1 inhibition strategies.

In conclusion, this example demonstrates a platform for rapidly screening drug combinations to determine the optimal drug combinations and dosages from a vast search space with multiple optimization parameters. The cascade FCS scheme allowed screening for drug combinations that are highly effective against HSV-1 infection and potentially limit or eliminate the toxic effects of some drugs by lowering their dosages. This will open new avenues into treatment of HSV-1 infection by providing drug combinations that are much more effective than acyclovir treatment alone. In the searches that resulted in combinations DE1 and DE2, the two searches started with the same initial 16 drug combinations, but the different objective functions operating in the cascade FSC resulted in the identification of two distinct, though largely equally effective, drug combinations. This is especially important as the identification involved testing about 180 drug combinations, representing just about 0.1% of the 117,649 possible drug and dosage combinations.

As used herein, the singular terms “a,” “an,” and “the” include plural referents unless the context clearly dictates otherwise. Thus, for example, reference to an object can include multiple objects unless the context clearly dictates otherwise.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, the terms can refer to less than or equal to ±5%, such as less than or equal to ±4%, less than or equal to ±3%, less than or equal to ±2%, less than or equal to ±1%, less than or equal to ±0.5%, less than or equal to ±0.1%, or less than or equal to ±0.05%.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, operation or operations, to the objective, spirit and scope of the invention. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A method, comprising:
defining an objective function to optimize a combination of N input parameters of a complex system, wherein the objective function includes a weighted sum of n different optimization criteria, N≧2, and n≧2;
applying an initial combination of the N input parameters to the complex system to yield an initial output response;
executing an optimization procedure to generate an updated combination of the N input parameters, wherein executing the optimization procedure includes calculating an initial value of the objective function based on at least one of (a) the initial combination of the N input parameters and (b) the initial output response; and
applying the updated combination of the N input parameters to the complex system to yield an updated output response.

2. The method of claim 1, wherein the updated combination of the N input parameters is a first, updated combination of the N input parameters, the updated output response is a first, updated output response, and further comprising:
executing the optimization procedure to generate a second, updated combination of the N input parameters, wherein executing the optimization procedure includes calculating an updated value of the objective function based on at least one of (a) the first, updated combination of the N input parameters and (b) the first, updated output response; and
applying the second, updated combination of the N input parameters to the complex system to yield a second, updated output response.

3. The method of claim 1, further comprising adjusting a weighting factor of at least one of the n optimization criteria.

4. The method of claim 1, wherein the complex system is a biological system, and each of the N input parameters is a dosage of a respective drug from a group of N drugs.

5. The method of claim 4, wherein at least one of the n optimization criteria corresponds to drug efficacy.

6. The method of claim 5, wherein at least another one of the n optimization criteria is selected from drug toxicity, drug safety, drug side effect, drug tolerance, therapeutic window, drug dosage, drug resistance, and drug cost.

7. The method of claim 1, wherein executing the optimization procedure is carried out using an optimization technique.

8. The method of of claim 7, wherein the optimization technique is a stochastic optimization technique or a deterministic optimization technique.

9. A method, comprising:
defining an objective function to optimize a combination of N drugs, wherein the objective function includes a weighted sum of n different optimization criteria, at least one of the n optimization criteria corresponds to drug efficacy, N≧2, and n≧2;
conducting in vitro or in vivo tests by applying varying combinations of dosages of the N drugs to determine phenotypic responses corresponding to results of the tests;
fitting the results of the tests into a model of the objective function; and
using the model of the objective function, identifying at least one optimized combination of dosages of the N drugs.

10. The method of claim 9, wherein at least another one of the n optimization criteria is selected from drug toxicity, drug safety, drug side effect, drug tolerance, therapeutic window, drug dosage, and drug cost.

11. The method of claim 9, wherein conducting the in vivo tests is carried out on a human patient or a group of human patients.

12. The method of claim 9, wherein the model of the objective function is a mathematical model.

13. The method of claim 9, further comprising adjusting a weighting factor of at least one of the n optimization criteria.

14. The method of claim 13, wherein adjusting the weighting factor is carried out for a particular human patient or a particular group of human patients.

15. A method, comprising:
defining an objective function to optimize a combination of N input parameters of a complex system, wherein the objective function includes a weighted sum of n different optimization criteria, N≧2, and n≧2;
conducting multiple tests of the complex system by applying varying combinations of the N input parameters to determine output responses corresponding to results of the tests;
fitting the results of the tests into a model of the objective function; and
using the model of the objective function, identifying at least one optimized combination of the N input parameters.

16. The method of claim 15, wherein the complex system is a biological system, and each of the N input parameters is an amplitude of a respective therapeutic stimulus from a group of N therapeutic stimuli.

17. The method of claim 16, wherein at least one of the n optimization criteria corresponds to therapeutic efficacy.

18. The method of claim 17, wherein at least another one of the n optimization criteria is selected from therapeutic toxicity, therapeutic safety, therapeutic side effect, therapeutic tolerance, therapeutic window, therapeutic dosage, therapeutic resistance, and therapeutic cost.
